(19) United States
(12) Patent Application Publication
(10) Pub. No.: US 2024/0354611 A1
(43) Pub. Date: Oct. 24, 2024

(54) HETEROGENEOUS REPRESENTATION OF PARAMETRIZED QUANTUM CIRCUITS

(71) Applicant: Xanadu Quantum Technologies Inc., Toronto (CA)

(72) Inventors: Lars Theodor Isacsson, North Vancouver (CA); Mikhail Andrenkov, Toronto (CA)

(21) Appl. No.: 18/339,338

(22) Filed: Jun. 22, 2023

Related U.S. Application Data
(60) Provisional application No. 63/354,457, filed on Jun. 22, 2022.

(51) Int. Cl. G06N 10/20

(52) U.S. Cl. CPC G06N 10/20

(57) ABSTRACT

A system, method and computer program product for serializing and deserializing quantum circuits are provided. A high-level representation of a parameterized quantum circuit includes parameter data and circuit structure data. The high-level representation is serialized into a heterogenous representation that includes separate representation sections for the circuit structure and the parameter data of the parametrized circuit. The separate representation sections can be defined using different data formats. The circuit structure data and the parameter data can be extracted separately from the heterogeneous representation. The circuit structure and the parameter data of the parameterized circuit can then be deserialized separately. The deserialized representations can be combined to provide a quantum circuit object that can be used for execution by quantum hardware and/or a quantum simulator.

### CROSS REFERENCE TO RELATED APPLICATIONS

This application claims the benefit of U.S. Provisional Patent Application Ser. No. 63/354,457, filed Jun. 22, 2022, the entire contents of which is hereby incorporated by reference.

### FIELD

This document relates to systems and methods for processing quantum circuits. In particular, this document relates to systems and methods for serializing and deserializing parametrized quantum circuits.

### BACKGROUND

As access to advanced quantum hardware increases, the size and complexity of quantum circuits that can be executed also increases. As the size of the quantum circuit increases, a larger volume of data needs to be processed as the code representation of the quantum circuit is analyzed, optimized, and compiled. This results in increased parsing overhead as well as increased data overhead, particularly for remote applications of quantum computing.

### SUMMARY

The following summary is intended to introduce the reader to various aspects of the detailed description, but not to define or delimit any invention.

Systems, methods and computer program products for serializing and deserializing quantum circuits are provided. More particularly, in some examples, a parameterized quantum circuit can be converted into a serialized representation that includes separate sections for the circuit structure and the parameter values of the parametrized circuit. The separate representation sections may be defined using different representation formats. The circuit structure and the parameter values of the parameterized circuit can be parsed separately. The parsed representations can then be combined to provide a quantum circuit object that can be used for execution by quantum hardware and/or a quantum simulator.

According to some aspects, the present disclosure provides a method comprising: identifying circuit structure data in a high-level quantum circuit representation defined in a high-level programming language, the circuit structure data defining an arrangement of a plurality of quantum gates in a quantum circuit to be executed by a quantum simulator or quantum hardware; identifying parameter data in the high-level quantum circuit representation, the parameter data defining a plurality of parameters of the quantum circuit; translating the circuit structure data into an intermediate circuit structure representation defined in a quantum intermediate representation language; translating the parameter data into an intermediate parameter representation defined in a specified data format, wherein the specified data format is different from the quantum intermediate representation language; generating a parsed circuit structure representation and a parsed parameter representation by separately parsing the intermediate circuit structure representation and the intermediate parameter representation; and combining the parsed circuit structure representation and the parsed parameter representation into a combined quantum circuit.

The method can include sending a compiled quantum circuit to a quantum simulator or quantum hardware for execution, where the compiled quantum circuit is the combined quantum circuit or the compiled quantum circuit is generated by compiling the combined quantum circuit.

The specified data format can be different from the quantum intermediate representation language.

The quantum intermediate representation language can be a text-based format.

The specified data format can be a binary format.

Combining the parsed circuit structure representation and the parsed parameter representation into the combined quantum circuit can include, for each parameter in the plurality of parameters: determining a corresponding parameter location in the parsed circuit structure representation; and inserting a parameter value of that parameter at the corresponding parameter location.

The method can include identifying an associative map for the quantum circuit; and determining the corresponding parameter value for each parameter location using the associative map.

The method can include receiving at least one request message containing the high-level quantum circuit representation; and extracting the circuit structure data and the parameter data from the at least one request message.

According to some aspects, there is provided a non-transitory computer readable medium storing computer-executable instructions, which, when executed by a computer processor, cause the computer processor to carry out a method that includes identifying circuit structure data in a high-level quantum circuit representation defined in a high-level programming language, the circuit structure data defining an arrangement of a plurality of quantum gates in a quantum circuit to be executed by a quantum simulator or quantum hardware; identifying parameter data in the high-level quantum circuit representation, the parameter data defining a plurality of parameters of the quantum circuit; translating the circuit structure data into an intermediate circuit structure representation defined in a quantum intermediate representation language; translating the parameter data into an intermediate parameter representation defined in a specified data format; generating a parsed circuit structure representation and a parsed parameter representation by separately parsing the intermediate circuit structure representation and the intermediate parameter representation; and combining the parsed circuit structure representation and the parsed parameter representation into a combined quantum circuit.

The method can include sending a compiled quantum circuit to a quantum simulator or quantum hardware for execution, where the compiled quantum circuit is the combined quantum circuit or the compiled quantum circuit is generated by compiling the combined quantum circuit.

The specified data format can be different from the quantum intermediate representation language.

The quantum intermediate representation language can be a text-based format.

The specified data format can be a binary format.

Combining the parsed circuit structure representation and the parsed parameter representation into the combined quantum circuit can include, for each parameter in the plurality of parameters: determining a corresponding parameter location in the parsed circuit structure representation; and inserting a parameter value of that parameter at the corresponding parameter location.

The method can include identifying an associative map for the quantum circuit; and determining the corresponding parameter value for each parameter location using the associative map.

The method can include receiving at least one request message containing the high-level quantum circuit representation; and extracting the circuit structure data and the parameter data from the at least one request message

According to some aspects, there is also provided a computer system comprising a processor, a computer-readable memory, and a non-transitory computer readable medium storing computer-executable instructions, which, when executed by the processor, cause the processor to carry out a method comprising: identifying circuit structure data in a high-level quantum circuit representation defined in a high-level programming language, the circuit structure data defining an arrangement of a plurality of quantum gates in a quantum circuit to be executed by a quantum simulator or quantum hardware; identifying parameter data in the high-level quantum circuit representation, the parameter data defining a plurality of parameters of the quantum circuit; translating the circuit structure data into an intermediate circuit structure representation defined in a quantum intermediate representation language; translating the parameter data into an intermediate parameter representation defined in a specified data format; generating a parsed circuit structure representation and a parsed parameter representation by separately parsing the intermediate circuit structure representation and the intermediate parameter representation; and combining the parsed circuit structure representation and the parsed parameter representation into a combined quantum circuit.

The method can include sending a compiled quantum circuit to a quantum simulator or quantum hardware for execution, where the compiled quantum circuit is the combined quantum circuit or the compiled quantum circuit is generated by compiling the combined quantum circuit.

The specified data format can be different from the quantum intermediate representation language.

The quantum intermediate representation language can be a text-based format.

The specified data format can be a binary format.

Combining the parsed circuit structure representation and the parsed parameter representation into the combined quantum circuit can include, for each parameter in the plurality of parameters: determining a corresponding parameter location in the parsed circuit structure representation; and inserting a parameter value of that parameter at the corresponding parameter location.

The method can include identifying an associative map for the quantum circuit; and determining the corresponding parameter value for each parameter location using the associative map.

The method can include receiving at least one request message containing the high-level quantum circuit representation; and extracting the circuit structure data and the parameter data from the at least one request message.

According to some aspects, the present disclosure provides a method comprising: identifying circuit structure data in a quantum circuit representation, the circuit structure data defining an arrangement of a plurality of quantum gates in a quantum circuit to be executed by a quantum simulator or quantum hardware; identifying parameter data in the quantum circuit representation, the parameter portion defining a plurality of parameters of the quantum circuit; generating a parsed circuit structure representation by parsing the circuit structure data; generating a parsed parameter representation by parsing the parameter data, wherein the parameter data is parsed separately from the circuit structure data; and combining the parsed circuit structure representation and the parsed parameter representation into a combined quantum circuit.

The method can include sending a compiled quantum circuit to the quantum simulator or quantum hardware for execution, where the compiled quantum circuit is the combined quantum circuit or the compiled quantum circuit is generated by compiling the combined quantum circuit.

The circuit structure data and the parameter data can be defined using different formats.

The circuit structure data can be defined using a text-based format.

The parameter data can be defined using a binary format.

Combining the parsed circuit structure representation and the parsed parameter representation can include, for each parameter in the plurality of parameters: determining a corresponding parameter location in the parsed circuit structure data; and inserting a parameter value of that parameter at the corresponding parameter location.

The method can include determining an associative map associated with the quantum circuit representation; and determining the corresponding parameter value for each parameter location using the associative map.

The method can include receiving at least one request message for the execution of the quantum circuit; identifying delimiter data in the at least one request message; and identifying the associative map in the delimiter data.

The method can include receiving at least one request message for the execution of the quantum circuit; and identifying the circuit structure data and the parameter data in the at least one request message.

The quantum circuit representation can be a high-level quantum circuit representation defined in a high-level programming language and the method can include translating the circuit structure data into an intermediate circuit structure representation defined in a quantum intermediate representation language; generating the parsed circuit structure representation by parsing the intermediate circuit structure representation; translating the parameter data into an intermediate parameter representation defined in a specified data format; and generating the parsed parameter representation by parsing the intermediate parameter representation.

The method can include receiving at least one request message containing the high-level quantum circuit representation; and extracting the circuit structure data and the parameter data from the at least one request message.

According to some aspects, there is provided a non-transitory computer readable medium storing computer-executable instructions, which, when executed by a computer processor, cause the computer processor to carry out a method that includes identifying circuit structure data in a quantum circuit representation, the circuit structure data defining an arrangement of a plurality of quantum gates in a quantum circuit to be executed by a quantum simulator or quantum hardware; identifying parameter data in the quantum circuit representation, the parameter portion defining a plurality of parameters of the quantum circuit; generating a parsed circuit structure representation by parsing the circuit structure data; generating a parsed parameter representation by parsing the parameter data, wherein the parameter data is parsed separately from the circuit structure data; and combining the parsed circuit structure representation and the parsed parameter representation into a combined quantum circuit.

The method can include sending a compiled quantum circuit to the quantum simulator or quantum hardware for execution, where the compiled quantum circuit is the combined quantum circuit or the compiled quantum circuit is generated by compiling the combined quantum circuit.

The circuit structure data and the parameter data can be defined using different formats.

The circuit structure data can be defined using a text-based format.

The parameter data can be defined using a binary format.

Combining the parsed circuit structure representation and the parsed parameter representation can include, for each parameter in the plurality of parameters: determining a corresponding parameter location in the parsed circuit structure data; and inserting a parameter value of that parameter at the corresponding parameter location.

The method can include determining an associative map associated with the quantum circuit representation; and determining the corresponding parameter value for each parameter location using the associative map.

The method can include receiving at least one request message for the execution of the quantum circuit; identifying delimiter data in the at least one request message; and identifying the associative map in the delimiter data.

The method can include receiving at least one request message for the execution of the quantum circuit; and identifying the circuit structure data and the parameter data in the at least one request message.

The quantum circuit representation can be a high-level quantum circuit representation defined in a high-level programming language and the method can include: translating the circuit structure data into an intermediate circuit structure representation defined in a quantum intermediate representation language; generating the parsed circuit structure representation by parsing the intermediate circuit structure representation; translating the parameter data into an intermediate parameter representation defined in a specified data format; and generating the parsed parameter representation by parsing the intermediate parameter representation.

The method can include: receiving at least one request message containing the high-level quantum circuit representation; and extracting the circuit structure data and the parameter data from the at least one request message.

According to some aspects, there is also provided a computer system comprising a processor, a computer-readable memory, and a non-transitory computer readable medium storing computer-executable instructions, which, when executed by the processor, cause the processor to carry out a method comprising: identifying circuit structure data in a quantum circuit representation, the circuit structure data defining an arrangement of a plurality of quantum gates in a quantum circuit to be executed by a quantum simulator or quantum hardware; identifying parameter data in the quantum circuit representation, the parameter portion defining a plurality of parameters of the quantum circuit; generating a parsed circuit structure representation by parsing the circuit structure data; generating a parsed parameter representation by parsing the parameter data, wherein the parameter data is parsed separately from the circuit structure data; and combining the parsed circuit structure representation and the parsed parameter representation into a combined quantum circuit.

The method can include sending a compiled quantum circuit to the quantum simulator or quantum hardware for execution, where the compiled quantum circuit is the combined quantum circuit or the compiled quantum circuit is generated by compiling the combined quantum circuit.

The circuit structure data and the parameter data can be defined using different formats.

The circuit structure data can be defined using a text-based format.

The parameter data can be defined using a binary format.

Combining the parsed circuit structure representation and the parsed parameter representation can include, for each parameter in the plurality of parameters: determining a corresponding parameter location in the parsed circuit structure data; and inserting a parameter value of that parameter at the corresponding parameter location.

The method can include determining an associative map associated with the quantum circuit representation; and determining the corresponding parameter value for each parameter location using the associative map.

The method can include receiving at least one request message for the execution of the quantum circuit; identifying delimiter data in the at least one request message; and identifying the associative map in the delimiter data.

The method can include receiving at least one request message for the execution of the quantum circuit; and identifying the circuit structure data and the parameter data in the at least one request message.

The quantum circuit representation can be a high-level quantum circuit representation defined in a high-level programming language and the method can include: translating the circuit structure data into an intermediate circuit structure representation defined in a quantum intermediate representation language; generating the parsed circuit structure representation by parsing the intermediate circuit structure representation; translating the parameter data into an intermediate parameter representation defined in a specified data format; and generating the parsed parameter representation by parsing the intermediate parameter representation.

The method can include receiving at least one request message containing the high-level quantum circuit representation; and extracting the circuit structure data and the parameter data from the at least one request message.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a block diagram illustrating an example system for cloud-based quantum computing;

FIG. 2 is a flowchart illustrating an example of a method for serializing a quantum circuit representation;

FIG. 3 is a flowchart illustrating an example of a method for deserializing a quantum circuit representation;

FIG. 4A is a circuit diagram of an example quantum circuit;

FIG. 4B is a circuit diagram of the example quantum circuit of FIG. 4A including the parameter values associated with the rotation gates;

FIG. 5A is a high-level representation of the example quantum circuit shown in FIG. 4B defined in a high-level programming language;

FIG. 5B is a heterogeneous representation of the high-level representation shown in FIG. 5A;

FIG. 5C is an intermediate parameter representation of the parameter data of the high-level representation shown in FIG. 5A in a specified data format;

FIG. 5D is an intermediate circuit structure representation of the high-level representation shown in FIG. 5A in a quantum intermediate representation language;

FIG. 5E is a parsed parameter representation of the intermediate parameter representation shown in FIG. 5C;

FIG. 5F is a parsed circuit structure representation of the intermediate circuit structure representation shown in FIG. 5D; and

FIG. 5G is a quantum circuit object generated by combining the parsed parameter representation of FIG. 5E and the parsed circuit structure representation of FIG. 5F.

### DETAILED DESCRIPTION

Various apparatuses or processes or compositions will be described below to provide an example of an embodiment of the claimed subject matter. No embodiment described below limits any claim and any claim may cover processes or apparatuses or compositions that differ from those described below. The claims are not limited to apparatuses or processes or compositions having all of the features of any one apparatus or process or composition described below or to features common to multiple or all of the apparatuses or processes or compositions described below. It is possible that an apparatus or process or composition described below is not an embodiment of any exclusive right granted by issuance of this patent application. Any subject matter described below and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

For simplicity and clarity of illustration, reference numerals may be repeated among the figures to indicate corresponding or analogous elements. In addition, numerous specific details are set forth in order to provide a thorough understanding of the subject matter described herein. However, it will be understood by those of ordinary skill in the art that the subject matter described herein may be practiced without these specific details. In other instances, well-known methods, procedures and components have not been described in detail so as not to obscure the subject matter described herein. The description is not to be considered as limiting the scope of the subject matter described herein.

The terms “coupled” or “coupling” as used herein can have several different meanings depending on the context in which these terms are used. For example, the terms coupled or coupling can have a mechanical, electrical or communicative connotation. For example, as used herein, the terms coupled or coupling can indicate that two elements or devices can be directly connected to one another or connected to one another through one or more intermediate elements or devices via an electrical element, electrical signal, or a mechanical element depending on the particular context.

Furthermore, the term “communicative coupling” may be used to indicate that an element or device can electrically, optically, or wirelessly send data to another element or device as well as receive data from another element or device.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Terms of degree such as “substantially”, “about” and “approximately” as used herein mean a reasonable amount of deviation of the modified term such that the end result is not significantly changed. These terms of degree may also be construed as including a deviation of the modified term if this deviation would not negate the meaning of the term it modifies.

Any recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

Described herein are systems, methods and computer program products for serializing and deserializing parametrized quantum circuits. A quantum circuit can be represented using a heterogenous representation structure that includes separate representation sections for the circuit structure and for the parameter values of the quantum circuit. The circuit structure and circuit parameters can then be parsed separately. This may simplify the process of parsing the circuit structure and/or parameters. The representation segments may be defined using different formats, which may help reduce the data size of a byte stream that represents the quantum circuit in a serialized manner.

The systems, methods, and devices described herein may be implemented as a combination of hardware or software. In some cases, the systems, methods, and devices described herein may be implemented, at least in part, by using one or more computer programs, executing on one or more programmable devices including at least one processing element, and a data storage element (including volatile and non-volatile memory and/or storage elements). These devices may also have at least one input device (e.g. a pushbutton keyboard, mouse, a touchscreen, and the like), and at least one output device (e.g. a display screen, a printer, a wireless radio, and the like) depending on the nature of the device.

Some elements that are used to implement at least part of the systems, methods, and devices described herein may be implemented via software that is written in a high-level procedural language such as object-oriented programming. Accordingly, the program code may be written in any suitable programming language such as Python or C for example. Alternatively, or in addition thereto, some of these elements implemented via software may be written in assembly language, machine language or firmware as needed. In either case, the language may be a compiled or interpreted language.

At least some of these software programs may be stored on a storage media (e.g. a computer readable medium such as, but not limited to, ROM, magnetic disk, optical disc) or a device that is readable by a general or special purpose programmable device. The software program code, when read by the programmable device, configures the programmable device to operate in a new, specific and predefined manner in order to perform at least one of the methods described herein.

Furthermore, at least some of the programs associated with the systems and methods described herein may be capable of being distributed in a computer program product comprising a computer readable medium that bears computer usable instructions for one or more processors. The medium may be provided in various forms, including non-transitory forms such as, but not limited to, one or more diskettes, compact disks, tapes, chips, and magnetic and electronic storage. Alternatively, the medium may be transitory in nature such as, but not limited to, wire-line transmissions, satellite transmissions, internet transmissions (e.g. downloads), media, digital and analog signals, and the like. The computer useable instructions may also be in various formats, including compiled and non-compiled code.

The present disclosure relates to a system, method, and computer program product for processing parametrized quantum circuits. After a quantum circuit is defined using a high-level programming language, the quantum circuit may be serialized for storage and/or transmission over a network. This may be useful where the quantum circuit needs to be stored for later execution (e.g. because there is a job queue for the quantum hardware) and/or where the quantum circuit is being sent to a remote (e.g. cloud-based) quantum computing system for execution. The serialized quantum circuit will then need to be deserialized before the quantum circuit can be executed by quantum hardware or a quantum simulator.

As quantum hardware and the associated quantum circuits become more complex, the volume of data required to represent a given quantum circuit increases. Efficiently representing a quantum circuit can help reduce the parsing overhead involved in deserializing a quantum circuit before it runs on quantum hardware and/or quantum simulators.

Currently, quantum computing hardware is expensive, and access is limited. It is often impractical for individual users to directly access quantum computing hardware in order to run quantum circuits. As a result, access to quantum computing hardware is often provided in a cloud environment over a network. Examples of cloud-based quantum computing systems include the Xanadu Cloud and the IBM Q Experience among many others. As more advanced quantum hardware becomes available through cloud services, the need to represent advanced quantum circuits with many parameters in a manner that is both human-readable and efficient grows in tandem.

A typical approach to executing a quantum circuit on remote quantum hardware involves serializing an intuitive, high-level description of a quantum circuit (e.g., a Python function) into an intermediate representation (IR) such as QIR or Blackbird. This serialized representation of the quantum circuit is then included in the payload of an HTTP request message to a compatible cloud service endpoint. While this approach is suitable for simple quantum programs, it can become prohibitive for more complex quantum circuits. For example, quantum circuits that embed thousands or millions of parameters may result in prohibitive circuit data sizes if numbers are encoded using a text-based format (e.g., UTF-8). Encoding a significant volume of parameter values (i.e. numbers) using data formats that do not efficiently represent numbers (such as text-based formats) can result in unnecessarily large file sizes and significant parsing overhead.

The present disclosure may facilitate the serialization and deserialization of quantum circuits that include parameters by reducing data sizes and parsing requirements for parametrized quantum circuits.

A quantum circuit representation can be separated into two separate sections, a parameter data section and a circuit structure section. The parameter data section and the circuit structure section can be parsed separately. This may allow different parsing methods to be applied to the parameter data section and the circuit structure section, which may alleviate parsing overhead particularly for large quantum circuits.

Generally, the main requirement for the selected data formats is that the circuit structure representation allows for data parameter values to be subsequently reinserted into a deserialized circuit structure representation prior to running on quantum hardware/simulators. This may involve inserting placeholder data into the representation of the circuit structure section at the parameter locations. Alternatively, a templating layer can be added to the representation format of the circuit structure section to allow the parameter locations to be identified.

Alternatively or in addition, an associative mapping may be provided to identify the parameter location associated with a given parameter value. The associative mapping can be stored using metadata associated with the parameter data section and the circuit structure section. An associative mapping may provide a common interface that allows various combinations of data formats to be used, which can improve the flexibility of the resulting serialization/deserialization pipeline.

Depending on the requirements of a given implementation, the data format selected to represent the parameter data section and/or the circuit structure section may vary. For example, a text-based format such as a JSON format may be selected to facilitate readability and debugging of a quantum circuit. Alternatively, a binary format (e.g. an .npz format or .npy format) may be used to represent the parameter data section to optimize deserialization performance.

In some examples, the parameter data section and the circuit structure section may be represented using the same data format. This may simplify management and maintenance of the system(s) performing serialization and deserialization as only one serialization and deserialization library is needed to perform the serialization and deserialization of both the parameter data section and the circuit structure section. Using the same data format may also facilitate validation of the heterogeneous circuit representation, e.g. validating the parameter representation in the context of the circuit representation so that each parameter in the parameter representation appears in the circuit representation, and each parameter in the circuit representation appears in the parameter representation.

Alternatively, the parameter data section and the circuit structure section may be represented using different data formats. For example, a text-based format may be used to represent the circuit structure section while a binary format is used to represent the parameter data section. This may reduce the total data size required to represent the serialized quantum circuit by using a binary format to represent the numerical parameter values rather than a text-based format.

The parameter data and the circuit structure can be identified in a representation of the quantum circuit. The quantum circuit can be serialized by representing the parameter data using an intermediate parameter representation and representing the circuit structure data using an intermediate circuit structure representation. The parameter data and the circuit structure identified in the representation of the quantum circuit can be translated, respectively, to the intermediate parameter representation and the intermediate circuit structure representation.

The intermediate parameter representation can be defined using a specified parameter format selected to represent the parameter data. The intermediate circuit structure representation can be defined using a specified circuit structure format selected to represent the circuit structure data. The intermediate parameter representation and the intermediate circuit structure representation can be combined into a heterogeneous serialized representation of the quantum circuit. The serialized representation of the quantum circuit can be used for storage and/or transmission of the quantum circuit.

The serialized representation of the quantum circuit can be defined by concatenating the intermediate parameter representation and the intermediate circuit structure representation together in a sequence of bytes (e.g. a byte stream). The serialized representation of the quantum circuit can include a parameter section (containing the intermediate parameter representation) and a circuit structure section (containing the intermediate circuit structure representation).

A delimiter can be defined to identify the location of the intermediate parameter representation and the location of the intermediate circuit structure representation. The delimiter may define a boundary between the intermediate parameter representation and the intermediate circuit structure representation. The delimiter can be defined as one or more specified bit values included in the sequence of bytes (e.g. specified bit values located between the intermediate parameter representation and the intermediate circuit structure representation).

The serialized representation of the quantum circuit can include additional metadata relating to the intermediate parameter representation and/or the intermediate circuit structure representation. Optionally, the metadata can be contained within the delimiter.

The metadata can specify information relating to the specified parameter format and/or the specified circuit structure format. This may facilitate the deserialization of varied combinations of specified parameter formats and specified circuit structure formats.

The metadata can also include mapping data between the intermediate parameter representation and the intermediate circuit structure representation. The mapping data may define an associative map that identifies a correspondence between the parameter values contained in the intermediate parameter representation and the parameter locations contained in the intermediate circuit structure location. The mapping data can be used to recombine the parameter section and circuit structure section into a quantum circuit object that is usable for execution by a quantum computing system.

To deserialize the quantum circuit, the parameter section and the circuit structure section can be identified in the serialized representation of the quantum circuit. For example, the parameter section and the circuit structure section can be identified using the delimiter. The intermediate parameter representation and the intermediate circuit structure representation can then be individually deserialized. Depending on the specified parameter format and the specified circuit structure format, different parsers may be used to deserialize the intermediate parameter representation and the intermediate circuit structure representation. For example, the performance requirements for deserializing the intermediate circuit structure representation may be relaxed where the intermediate circuit structure representation omits complex and floating-point numbers (that are contained in the intermediate parameter representation).

The parsed parameter representation and the parsed circuit structure representation can then be combined to provide a deserialized quantum circuit object. The parameter values from the parsed parameter representation can be inserted at their respective parameter locations in the parsed circuit structure representation to generate the quantum circuit object.

The quantum circuit may be compiled prior to serialization or after deserialization. Where the quantum circuit is compiled prior to serialization, the combined quantum circuit generated by combining the parsed parameter representation and the parsed circuit structure representation can be a compiled quantum circuit. Where the quantum circuit is compiled after deserialization, a compiled quantum circuit can be generated by compilation of the combined quantum circuit.

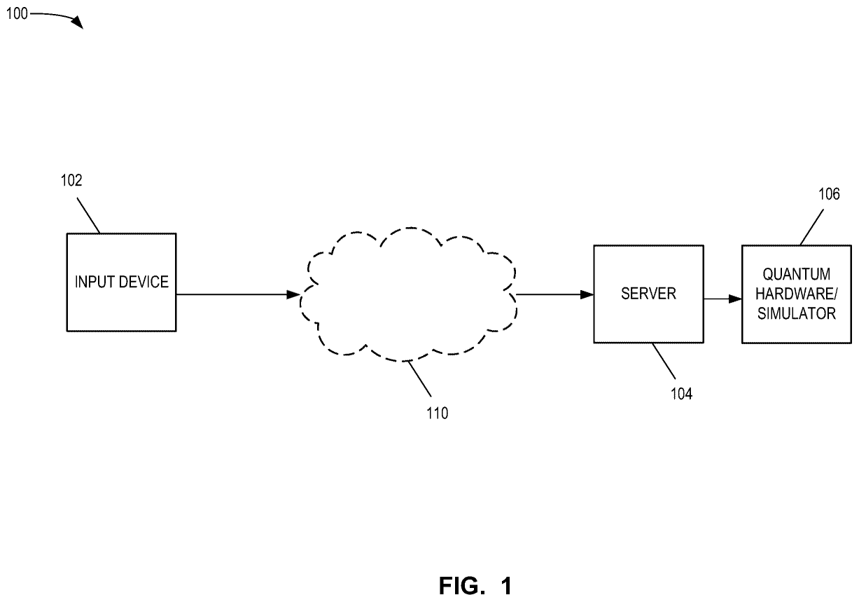

Referring now to FIG. 1, shown therein is a block diagram illustrating an example processing system 100. Processing system 100 is an example of a system that can be used to provide cloud-based quantum computing.

In the example illustrated, system 100 includes an input device 102, a server 104, and quantum hardware/simulator 106. The input device 102 can be configured to define a representation of a quantum circuit in a high-level programming level (e.g. Python). This high-level quantum circuit representation can be provided to the server 104 for optimization, compilation and execution via the quantum hardware/simulator 106.

Alternatively, the input device 102 may perform some processing of the high-level quantum circuit representation. For example, the input device 102 may translate the high-level quantum circuit representation into an intermediate representation that is then provided to the server 104 for further optimization, compilation and execution via the quantum hardware/simulator 106.

Alternatively or in addition, the input device 102 may compile the quantum circuit representation before providing an intermediate representation of the compiled quantum circuit to the server 104.

The input device 102 can be communicatively coupled with the server 104, e.g. using a wired or wireless communication module (e.g., Bluetooth, Bluetooth Low-Energy, WiFi, ANT+ IEEE 802.11, etc.). The input device 102 can also be communicatively coupled to the server 104 over, for example, a wide area network 110 such as the Internet.

The input device 102 generally refers to any processing unit capable of providing a user interface to enable a user to define a high-level representation of a quantum circuit. The processing unit 102 can also provide a representation of the quantum circuit (e.g. the high-level representation or an intermediate representation) to the server 104. The input device 102 can provide a user interface through a locally installed application that allows a user to define the high-level representation of the quantum circuit locally on the input device 102. Alternatively or in addition, the user interface may be provided through a web application or web browser accessible through the input device 102.

The input device 102 can be implemented using a processor such as a general purpose microprocessor. The processor controls the operation of the input device 102 and in general can be any suitable processor such as a microprocessor, controller, digital signal processor, field programmable gate array, application specific integrated circuit, microcontroller, or other suitable computer processor that can provide sufficient processing power, depending on the desired configuration, for the purposes and requirements of the system 100.

The input device 102 can include the processor, a power supply, memory, at least one input device (e.g. a pushbutton keyboard, mouse, a touchscreen, and the like), and at least one output device (e.g. a display screen) and a communication module operatively coupled to the processor. The memory unit can include RAM, ROM, one or more hard drives, one or more flash drives or some other suitable data storage elements such as disk drives, etc.

The server 104 can be implemented using a processor such as a general purpose microprocessor. The processor controls the operation of the server 104 and in general can be any suitable processor such as a microprocessor, controller, digital signal processor, field programmable gate array, application specific integrated circuit, microcontroller, or other suitable computer processor that can provide sufficient processing power, depending on the desired configuration, purposes and requirements of the system 100.

The server 104 can include the processor, a power supply, memory, and a communication module operatively coupled to the processor and to the quantum hardware/simulator 106. The memory can include RAM, ROM, one or more hard drives, one or more flash drives or some other suitable data storage elements such as disk drives, etc.

The server 104 can be communicatively coupled to one or more quantum hardware or simulator systems 106, e.g. using a wired or wireless communication module (e.g., Bluetooth, Bluetooth Low-Energy, WiFi, ANT+IEEE 802.11, etc.). The server 104 can also be communicatively coupled to a quantum hardware or simulator systems 106 over, for example, a wide area network such as the Internet.

Optionally, the server 104 can be coupled directly to quantum hardware or simulator systems 106. For example, the quantum hardware or simulator systems 106 may be coupled to the communication module (and thereby the server 104) using a wired connection such as Universal Serial Bus (USB) or other port. Although shown separately, the quantum hardware or simulator systems 106 may be co-located or combined with, the server 104.

The quantum hardware or simulator systems 106 can be implemented using one or more quantum computing systems including quantum processors and/or quantum simulators and/or quantum emulators. Various different types of quantum computing systems can be used to provide the quantum hardware or simulator systems 106 depending on the implementation of system 100.

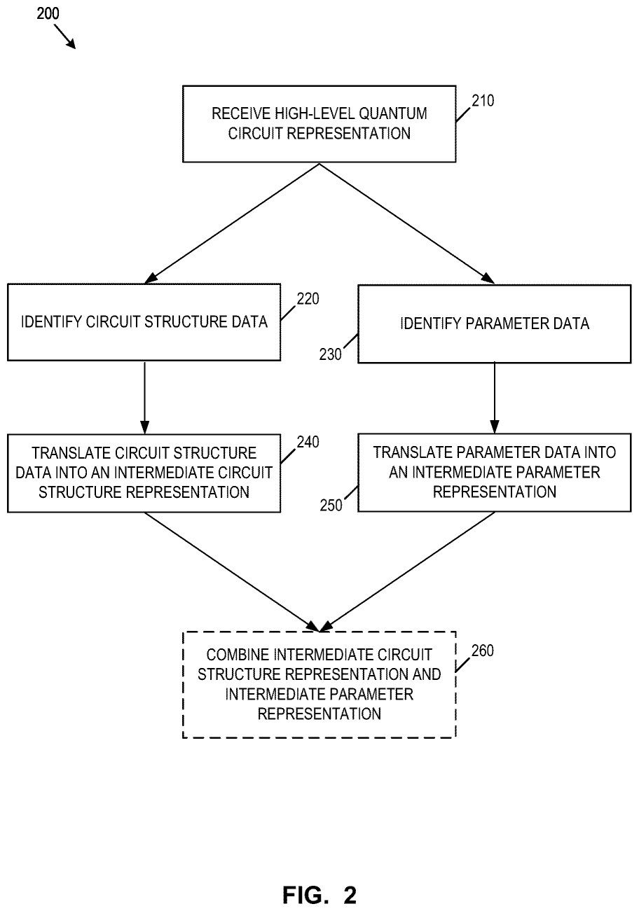

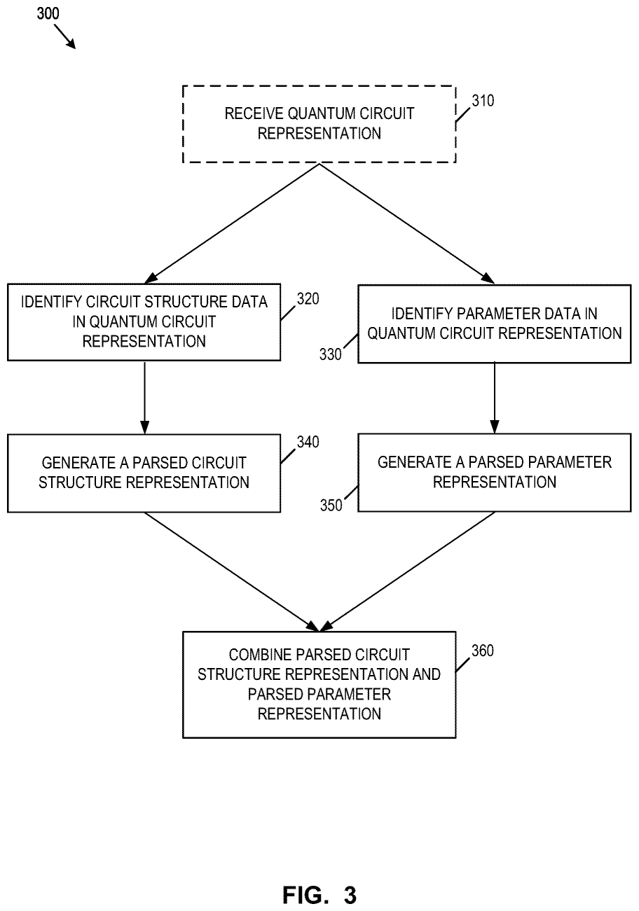

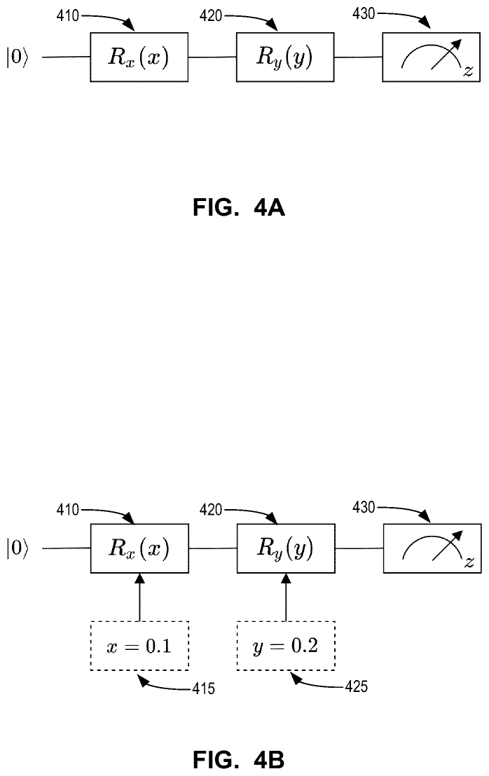

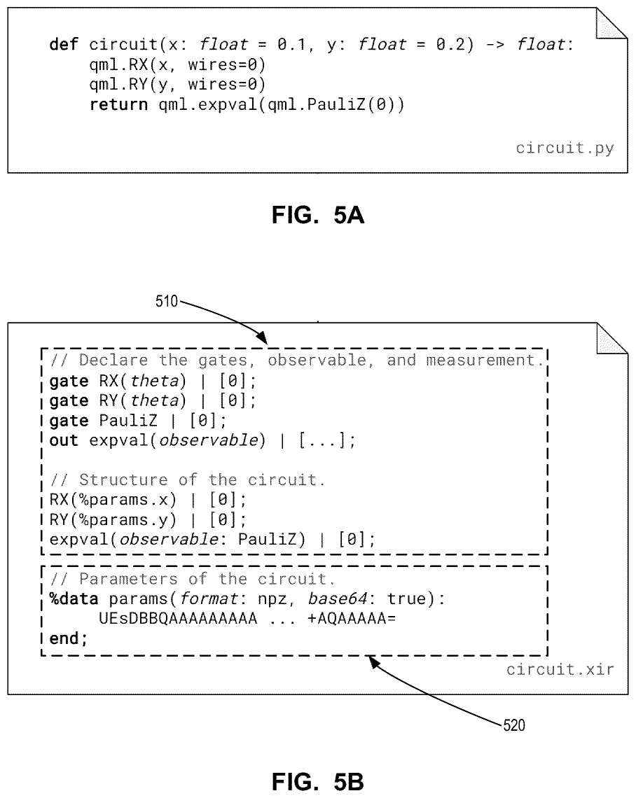

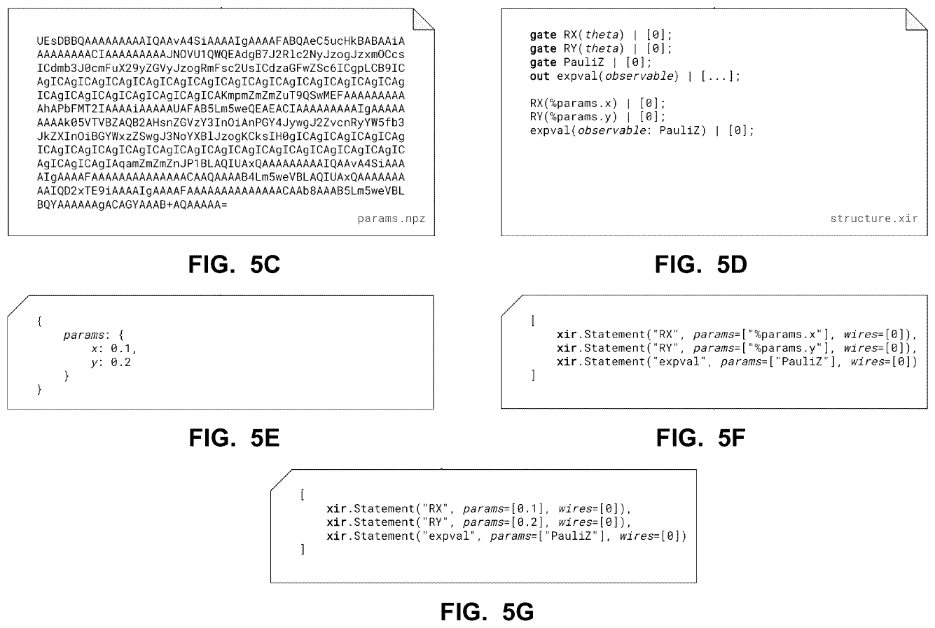

Described herein below are examples of methods for serializing (see e.g. FIG. 2) and processing (see e.g. FIG. 3) quantum circuit representations. Throughout the discussion that follows, reference will be made concurrently to the example quantum circuits shown in FIGS. 4A-4B as well as corresponding representations of those example quantum circuits shown in FIGS. 5A-5G.

Referring now to FIG. 4A, shown therein is a circuit diagram of an example quantum circuit. The quantum circuit shown in FIG. 4A is an example of a simple quantum circuit that includes a first rotation gate 410, a second rotation gate 420, and a measurement 430 in the Pauli-Z basis.

Rotation gates 410 and 420 are examples of quantum logic gates that are often defined with associated parameters. FIG. 4B illustrates a parametrized circuit diagram of the example quantum circuit shown in FIG. 4A. As shown in FIG. 4B, the rotation gates 410 and 420 have associated parameters 415 and 425 respectively.

The example parametrized quantum circuit shown in FIG. 4B is an example of a very simple quantum circuit with few gates and parameters. However, as the number of parametrized gates increases, the data size of the quantum circuit representations increases. As a result, an efficient method of representing and parsing quantum circuits can provide advantages in terms of data overhead as well as parsing overhead when quantum circuits are being optimized and compiled for execution.

Referring now to FIG. 2, shown therein is an example method 200 for generating a serialized representation of a quantum circuit. Serialization refers to the process of converting an object instance (e.g. a quantum circuit object) to a format that is suitable for storage and/or for transport across a network. The serialized representation can subsequently be deserialized to reconstruct the object from the serialized state (e.g. using method 300 described herein below). Method 200 is an example of a method for generating a serialized representation of a quantum circuit in which the parameters and the circuit structure of the quantum circuit can be represented separately.

The method 200 may be used with a system for processing quantum circuits such as the cloud-based system 100 for example. It should be understood that method 200 can also be used with other systems for processing quantum circuits including non-cloud-based quantum execution systems.

Depending on the particular implementation, the method 200 can be implemented by one or more components of the system 100, such as the input device 102 and server 104. Optionally, all of the steps of method 200 may be performed at the input device 102 (e.g. prior to sending an intermediate representation of a quantum circuit to the server 104 for execution and/or prior to storing the intermediate representation of the quantum circuit).

Alternatively, some or all of the steps of method 200 may be performed by the server 104 (e.g. where the input device 102 is used to generate a high-level definition of a quantum circuit that is provided directly to the server 104 for execution). This may simplify the adoption of method 200 by existing quantum circuit processing systems, for instance where quantum execution jobs are normally represented by a single circuit file.

The quantum circuit may be compiled or uncompiled prior to serialization. For example, the quantum circuit may be compiled on the client-side (e.g. at input device 102) by mapping the quantum circuit to an exact parametrization of a hardware device or simulator 106. Alternatively, the quantum circuit may be serialized prior to compilation. In such cases, the quantum circuit can be compiled after being deserialized (e.g. after step 360 of method 300 described herein below).

At 210, a high-level representation of a quantum circuit can be received. The high-level representation can be a high-level quantum circuit representation defined in a high-level programming language.

FIG. 5A illustrates an example of a high-level quantum circuit representation defined using a high-level programming language, in this example Python. The example high-level quantum circuit representation shown in FIG. 5A is a high-level representation of the parameterized quantum circuit shown in FIG. 4B. As can be seen from FIG. 5A, the high-level quantum circuit representation includes a definition of the first rotation gate 410 (qml.RX), the second rotation gate 420 (qml.Ry), and the Pauli-Z operator 430 (qml.PauliZ). The high-level quantum circuit representation also includes a definition of the circuit parameters 415 (x) and 425 (y) as floating point numbers.

Optionally, the high-level quantum circuit representation may be contained in at least one request message. The at least one request message can include a request to execute the corresponding quantum circuit represented by the high-level quantum circuit representation. For example, the at least one request message may be transmitted by a user input device (e.g. input device 102) to a server (e.g. server 104) that provides remote access to quantum hardware and/or a quantum simulator (e.g. quantum hardware/simulator 106).

Alternatively or in addition, the high-level quantum circuit representation may be received through a user interface provided by the server 104. For example, the server 104 may provide a circuit definition user interface (e.g. a web-based interface provided through a webpage or web app) that is accessible to the input device 102 e.g. over network 110. A user of input device 102 may interact with the circuit definition interface to provide the high-level definition of the quantum circuit directly to the server interface.

Alternatively, the high-level quantum circuit representation may be received by the input device 102 (e.g. through a local circuit definition application operating on the input device 102). A user of input device 102 may interact with the local circuit definition interface to provide the high-level definition of the quantum circuit to the input device 102.

Steps 220-260 can be performed by either of the input device 102 or server 104 depending on whether the high-level representation is received at 210 by the input device 102 or server 104. That is, it should be understood in the discussion of steps 220-260 that the functionality described therein can be implemented by either or both of the input device 102 and/or server 104 depending on the particular implementation of method 200.

At 220, circuit structure data can be identified in the high-level quantum circuit representation received at 210. The circuit structure data can define a plurality of quantum gates in a quantum circuit to be executed by a quantum simulator or quantum hardware. The circuit structure data can also define the arrangement of the quantum gates within the quantum circuit as well as any inputs and observables or measurements.

The circuit structure data can also include one or more parameter locations. Each parameter location can specify the location at which a parameter is included in a quantum circuit.

At 230, parameter data can be identified in the high-level quantum circuit representation received at 210. The parameter data can define one or more parameter values of the parameters included in the quantum circuit.

The identification of the circuit structure data and parameter data can depend on the implementation of method 200. For instance, the process of identifying the circuit structure data and parameter data may vary depending on the high-level language used to define the high-level representation received at 210.

The process of disaggregating the parameter data and circuit structure data may vary depending on the type of high-level representation received at 210. For example, the parameter data may be easily identified where the high-level representation is defined using a programming language in which the parameters are defined as separate attributes (e.g. using the Strawberry Fields or PennyLane Python libraries developed by Xanadu Quantum Technologies).

As an example, the high-level quantum circuit representation can be defined using an object-oriented approach. Each quantum gate in the quantum circuit can be represented by a corresponding gate object (similarly, each measurement operator can be represented by a corresponding object). The type of each object can encode the parameters of the corresponding gate. The circuit structure data can be identified by iterating through the objects representing the gates and measurements in the circuit. Each parameter encoded for a corresponding gate can then be replaced with a placeholder (e.g. a reference to an associative map).

In an example, an associative map may be defined using an auto-incrementing counter to identify the parameters of the quantum circuit. The placeholder can then provide a reference to the corresponding counter value in the associative map. For the example circuit illustrated, the rotation gates 410 and 420 qml.RX(0.1, wires=0); qml.RY(0.2, wires=0) can be encoded using the XIR circuit structure RX (% params.counter_at_0)|[0]; RY (% params.counter_at_1)|[0]; where pa rams refers to an associative map with the contents {“counter_at_0”: 0.1, “counter_at_1”: 0.2}.

At 240, the circuit structure data can be translated into an intermediate circuit structure representation. The intermediate circuit structure representation can be defined using a quantum intermediate representation language.

The intermediate circuit structure representation can represent the circuit structure data identified at 220. The intermediate circuit structure representation can omit the parameter data (identified at 230) for the corresponding quantum circuit. This may allow the intermediate circuit structure representation to be defined using a quantum intermediate representation language that represents circuit structure data more easily or that does not (easily) support the representation of parameter values. Optionally, the intermediate circuit structure representation may include placeholder values in place of the parameter values.

Various different quantum intermediate representation languages may be used, such as Blackbird or XIR for example. The quantum intermediate representation language may be a text-based format such as the JavaScript Object Notation (JSON) format for example. A text-based format may facilitate review and debugging of the quantum circuit representation by a user.

FIG. 5D illustrates an example of an intermediate circuit structure representation defined using an XIR format as the quantum intermediate representation language. As shown in FIG. 5D, the circuit structure data is defined while using placeholder values for the circuit parameter values.

At 250, the parameter data can be translated into an intermediate parameter representation. The intermediate parameter representation can be defined using a specified data format.

The intermediate parameter representation can represent the parameter data identified at 230. The intermediate parameter representation can also omit circuit structure data (identified at 220) for the corresponding quantum circuit. This may allow the intermediate parameter representation to be defined using a specified data format that represents parameter data (e.g. floating point values) more easily and with a smaller data size.

Various different data formats may be used to provide the intermediate parameter representation, such as quantum IR languages (e.g. Blackbird or XIR), binary formats, or other text-based formats.

Optionally, the specified data format may be a binary format such as an .npz format or .npy format. This may allow the parameter values to be represented with a reduced data size and facilitate parsing of the parameter data. Binary formats such as .npz and .npy can then be encoded (e.g. for transmission or storage) using various encoding schemes such as Base64 for example.

FIG. 5C illustrates an example of an intermediate parameter representation defined using an .npz format as the specified data format that has been encoded using Base64. As in the example shown in FIG. 5C, defining the parameter data in an .npz format can facilitate subsequent parsing and processing of the parameter values and can reduce the data size of the encoded parameter data representation (e.g. using Base64) that is stored or transmitted.

Alternatively, the specified data format may be a text-based format such as JSON. This may provide enhanced utility for readability and debugging purposes.

Optionally, the specified data format used for the intermediate parameter representation can be different from the quantum intermediate representation language. For example, the quantum intermediate representation language may be a text-based format while the specified data format is a binary format.

Alternatively, the specified data format used for the intermediate parameter representation can be the same as the quantum intermediate representation language. For example, the specified data format and the quantum intermediate representation language may both be defined using quantum intermediate representations (e.g. XIR) or text-based formats more generally.

At 260, the intermediate parameter representation and the intermediate circuit structure representation can be combined into a combined serialized representation. The combined circuit representation can provide a heterogeneous representation of the quantum circuit with a circuit structure section and a separate parameter section. The circuit structure section and the parameter section may be defined using different data formats.

FIG. 5B illustrates an example of a heterogeneous representation of the high-level quantum circuit representation shown in FIG. 5A (and corresponding to the parameterized quantum circuit shown in FIG. 4B). The heterogeneous representation shown in FIG. 5b includes a parameter section 510 that includes the intermediate parameter representation and a circuit structure section 520 that includes the intermediate circuit structure representation from FIGS. 5C and 5D respectively.

The heterogeneous representation of the quantum circuit includes the circuit structure data and the parameter data defined separately. As shown, the circuit structure data, including the gate definitions and circuit structure, are defined using placeholders for the parameter values in the circuit structure portion 510. The parameter values are then defined in a separate portion 520 of the heterogeneous quantum circuit representation.

As can be seen from FIG. 5B, the circuit structure data and the parameter data are defined using different data formats, namely an XIR format for the circuit structure data and an .npz format for the parameter values.

The combined serialized representation can be used to transmit or store the quantum circuit for subsequent deserialization and execution. For example, the combined serialized representation may be included in one or more request messages transmitted to an external device e.g. from input device 102 to server 104. Alternatively or in addition, the combined serialized representation may be stored for subsequent processing e.g. in a processing queue e.g. by the input device 102 and/or server 104.

The combined serialized representation can include a mapping between the parameter values (in the intermediate parameter representation) and the parameter locations (in the intermediate circuit structure representation). The mapping can associate each of the parameter values with the corresponding parameter location for that parameter value. Each parameter value can have an associated parameter name or tag that can be associated with the corresponding parameter location.

Optionally, placeholder values may be inserted at the respective parameter locations as shown in FIGS. 5B and 5D. The placeholder values may identify the corresponding parameter name or tag of the parameter value that corresponds to that parameter location.

Alternatively or in addition, mapping data can be defined external to the intermediate parameter representation and the intermediate circuit structure representation. For example, metadata included with the serialized representation of the quantum circuit can be defined to include an associative mapping between the parameter values and respective parameter locations. The metadata may be included as part of the delimiter. Optionally, placeholder values may include pointers or other identifiers of the locations in the associative mapping that correspond to the parameter location associated with the placeholder value (e.g. identifying a counter value corresponding to that parameter location).

Referring now to FIG. 3, shown therein is an example method 300 for deserializing a quantum circuit representation. The method 300 may be used with a system for processing quantum circuits such as the cloud-based system 100 for example. It should be understood that method 300 can also be used with other systems for processing quantum circuits including non-cloud-based quantum execution systems. Depending on the particular implementation, the method 300 can be implemented by one or more components of the system 100, such as the server 104.

At 310, a quantum circuit representation can be received. The quantum circuit representation may be an intermediate representation of the quantum circuit such as the serialized representation generated at 260.

The quantum circuit representation may be received by the server 104 of a cloud-based quantum computing system. For example, the quantum circuit representation may be received in at least one request message for the execution of the corresponding quantum circuit. The at least one request message may be received from a device such as input device 102.

Alternatively, the quantum circuit representation may be received by another device such as input device 102. For example, the quantum circuit representation may be retrieved by the input device 102 from a local or remote storage location.

At 320, circuit structure data can be identified in the quantum circuit representation received at 310. The circuit structure data can define an arrangement of a plurality of quantum gates in a quantum circuit to be executed by a quantum simulator or quantum hardware. The circuit structure data can also identify measurements or observables and their arrangement within the quantum circuit.

At 330, parameter data can be identified in the quantum circuit representation received at 310. The parameter data can define a plurality of parameter values of the quantum circuit.

Although steps 320 and 330 are shown as separate steps, it should be understood that the circuit structure data and parameter data may be identified through a concurrent or parallel process. For example, the quantum circuit representation may be a heterogeneous representation that includes separate circuit structure and parameter sections. The circuit structure data and the parameter data may be identified by partitioning the quantum circuit representation into the respective circuit structure and parameter sections.

As noted above at 310, the quantum circuit representation may be received in at least one request message. The circuit structure data and the parameter data can then be extracted from the at least one request message.

The heterogeneous representation of the quantum circuit can be defined to include delimiter data identifying the parameter portion and the circuit structure portion of the heterogeneous representation. For example, the delimiter data may be one or more characters positioned between the parameter portion and the circuit structure portion of the heterogeneous representation. The circuit structure data and the parameter data can be identified based on the delimiter data included in the delimiter.

Optionally, the delimiter data can also include mapping data. The mapping data can define an associative map between the parameter values in the parameter section and the corresponding parameter locations in the circuit structure data.

At 340, a parsed circuit structure representation can be generated by parsing the circuit structure data identified at 320. The parsed circuit structure representation may be a circuit structure object generated by converting an intermediate circuit structure representation defined in a serialized form (i.e. as a stream of bytes) into a circuit structure object.

FIG. 5F illustrates an example of a circuit structure object. The example circuit structure object shown in FIG. 5F was generated by parsing the intermediate circuit structure representation from FIG. 5D. As shown in FIG. 5F, the parsed circuit structure representation includes placeholders (“% params.x”, “% params.y”) instead of the actual parameter values.

At 350, a parsed parameter representation can be generated by parsing the parameter data identified at 330. The parsed parameter representation may be a parameter object generated by converting an intermediate parameter representation defined in a serialized form (i.e. as a stream of bytes) into a parameter object.

FIG. 5E illustrates an example of a parameter object. The example parameter object shown in FIG. 5E was generated by parsing the intermediate parameter representation from FIG. 5C. As shown, the parsed parameter representation includes the actual parameter values corresponding to the parameter locations represented by the placeholder values in the circuit structure object shown in FIG. 5F.

As noted herein above, the circuit structure data and the parameter data can be defined using different formats. For example, the circuit structure data can be defined using a text-based format such as the XIR format shown in FIG. 5D while the parameter data is defined using a binary format such as the .npz format shown in FIG. 5C. This may allow different parsing techniques to be applied in steps 340 and 350. For instance, the circuit structure data can be parsed without needing to evaluate the numerical parameter values.

More generally, the process of parsing the circuit structure data and the parameter data (respectively) will depend on the format used to represent the circuit structure data and the parameter data. Parsing a particular data format is performed according to a set of parsing rules constituting the grammar of that data format or language. The parsing rules specify (among other things) a set of terminals (i.e., character patterns which describe integers, floating-point numbers, variable names, and so forth), and structures composed of terminals and/or other structures (including themselves). As the number and complexity of the parsing rules grow, the parser becomes slower and more complicated to maintain, test, and debug.

Separately parsing the circuit structure data and the parameter data can provide both improved performance and a simplified user experience. That is, a single parser that is capable of parsing different formats used to represent the circuit structure data and the parameter data will typically perform worse (from the perspective of both performance and developer experience) than two separate parsers, one of which is configured to parse only the specified data format of the circuit structure data and the other of which is configured to parse only the specified data format of the parameter data.

At 360, the parsed circuit structure representation and the parsed parameter representation can be combined. For example, the parsed circuit structure representation and the parsed parameter representation can be combined into a combined quantum circuit object. The combined quantum circuit object can then be used to generate a compiled quantum circuit for execution by the quantum hardware/simulator 106. The compiled quantum circuit can then be sent to the quantum simulator or quantum hardware for execution.

Combining the parsed circuit structure representation and the parsed parameter representation can involve inserting the parameter values from the parsed parameter representation into the parsed circuit structure representation. For each parameter in the plurality of parameters, a corresponding parameter location in the parsed circuit structure data can be determined. The parameter value can then be inserted at the corresponding parameter location.

The corresponding parameter location for a given parameter value may be identified using mapping data. The mapping data can define an associative map associated with the quantum circuit representation. The associative map can specify which parameter value corresponds to each parameter location in the quantum circuit. The parameter locations corresponding to each parameter value in the parsed parameter representation can then be determined using the associative map.

FIG. 5G illustrates an example of a combined quantum circuit object. As shown in FIG. 5G, the example combined quantum circuit object corresponds to the parsed circuit structure representation shown in FIG. 5F except that the placeholder values have been replaced with the actual parameter values from the parsed parameter representation shown in FIG. 5E. The combined quantum circuit object may then be provided for execution by a quantum computing system (e.g. quantum hardware/simulator/emulator systems).

As noted above, the combined quantum circuit object may already be compiled (e.g. where the quantum circuit is compiled prior to step 210) such that the compiled quantum circuit is the combined quantum circuit object. Alternatively the combined quantum circuit object may be uncompiled and the compiled quantum circuit can be generated by compiling the combined quantum circuit object (e.g. after step 360).

Optionally, additional optimizations may be performed on the quantum circuit representation at various points along the serialization/deserialization pipeline. The type of optimizations and the location along the pipeline where the optimizations are performed can vary depending on the nature of the quantum circuit as well as the implementation of the systems and methods described herein. For example, optimizations may be performed prior to serialization (e.g. applying quantum gate identities prior to step 210 of method 200), after deserialization (e.g. optimizing the combined quantum circuit object for a specific quantum hardware device or simulator after step 360 of method 300), or even during serialization (e.g. as part of the serialization into intermediate representation formats at step 240 and/or 250).

While the above description provides examples of one or more processes or apparatuses or systems, it will be appreciated that other processes or apparatuses or systems may be within the scope of the accompanying claims.

It will be understood that the embodiments described in this disclosure and the module, routine, process, thread, or other software component implementing the described methods/processes/frameworks may be realized using standard computer programming techniques and languages. The present application is not limited to particular processors, computer languages, computer programming conventions, data structures, other such implementation details. Those skilled in the art will recognize that the described methods/processes may be implemented as a part of computer-executable code stored in volatile or non-volatile memory, as part of an application-specific integrated chip (ASIC), etc.

As will be apparent to a person of skill in the art, certain adaptations and modifications of the described methods/processes/frameworks can be made, and the above discussed embodiments should be considered to be illustrative and not restrictive.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be re-visited.

We claim:

1. A method comprising:
identifying circuit structure data in a quantum circuit representation, the circuit structure data defining an arrangement of a plurality of quantum gates in a quantum circuit to be executed by a quantum simulator or quantum hardware;
identifying parameter data in the quantum circuit representation, the parameter data defining a plurality of parameters of the quantum circuit;
generating a parsed circuit structure representation by parsing the circuit structure data;
generating a parsed parameter representation by parsing the parameter data, wherein the parameter data is parsed separately from the circuit structure data; and
combining the parsed circuit structure representation and the parsed parameter representation into a combined quantum circuit.

2. The method of claim 1, further comprising sending a compiled quantum circuit to the quantum simulator or quantum hardware for execution, wherein the compiled quantum circuit is the combined quantum circuit or the compiled quantum circuit is generated by compiling the combined quantum circuit.

3. The method of claim 1, wherein the circuit structure data and the parameter data are defined using different formats.

4. The method of claim 1, wherein the circuit structure data is defined using a text-based format.

5. The method of claim 1, wherein the parameter data is defined using a binary format.

6. The method of claim 1, wherein combining the parsed circuit structure representation and the parsed parameter representation comprises, for each parameter in the plurality of parameters:
determining a corresponding parameter location in the parsed circuit structure data; and
inserting a parameter value of that parameter at the corresponding parameter location.

7. The method of claim 6, further comprising:
determining an associative map associated with the quantum circuit representation; and
determining the corresponding parameter value for each parameter location using the associative map.

8. The method of claim 7, further comprising:
receiving at least one request message for the execution of the quantum circuit;
identifying delimiter data in the at least one request message; and
identifying the associative map in the delimiter data.

9. The method of claim 1, further comprising:
receiving at least one request message for the execution of the quantum circuit; and
identifying the circuit structure data and the parameter data in the at least one request message.

10. The method of claim 1, wherein the quantum circuit representation is a high-level quantum circuit representation defined in a high-level programming language and the method comprises:
translating the circuit structure data into an intermediate circuit structure representation defined in a quantum intermediate representation language;
generating the parsed circuit structure representation by parsing the intermediate circuit structure representation;
translating the parameter data into an intermediate parameter representation defined in a specified data format; and
generating the parsed parameter representation by parsing the intermediate parameter representation.

11. The method of claim 10, further comprising:
receiving at least one request message containing the high-level quantum circuit representation; and
extracting the circuit structure data and the parameter data from the at least one request message.

12. A computer system comprising a processor, a computer-readable memory, and a non-transitory computer readable medium storing computer-executable instructions, which, when executed by the processor, cause the processor to carry out a method comprising:
identifying circuit structure data in a quantum circuit representation, the circuit structure data defining an arrangement of a plurality of quantum gates in a quantum circuit to be executed by a quantum simulator or quantum hardware;
identifying parameter data in the quantum circuit representation, the parameter data defining a plurality of parameters of the quantum circuit;
generating a parsed circuit structure representation by parsing the circuit structure data;
generating a parsed parameter representation by parsing the parameter data, wherein the parameter data is parsed separately from the circuit structure data; and
combining the parsed circuit structure representation and the parsed parameter representation into a combined quantum circuit.

13. The computer system of claim 12, wherein the method further comprises sending a compiled quantum circuit to the quantum simulator or quantum hardware for execution, wherein the compiled quantum circuit is the combined quantum circuit or the compiled quantum circuit is generated by compiling the combined quantum circuit.

14. The computer system of claim 12, wherein the circuit structure data is defined using a text-based format and the parameter data is defined using a binary format.

15. The computer system of claim 12, wherein combining the parsed circuit structure representation and the parsed parameter representation comprises, for each parameter in the plurality of parameters:
determining a corresponding parameter location in the parsed circuit structure data; and
inserting a parameter value of that parameter at the corresponding parameter location.

16. The computer system of claim 15, wherein the method further comprises:
determining an associative map associated with the quantum circuit representation; and
determining the corresponding parameter value for each parameter location using the associative map.

17. The computer system of claim 16, wherein the method further comprises:
receiving at least one request message for the execution of the quantum circuit;
identifying delimiter data in the at least one request message; and
identifying the associative map in the delimiter data.

18. The computer system of claim 12, wherein the method further comprises:
receiving at least one request message for the execution of the quantum circuit; and
identifying the circuit structure data and the parameter data in the at least one request message.

19. The computer system of claim 12, wherein the quantum circuit representation is a high-level quantum circuit representation defined in a high-level programming language and the method comprises:
translating the circuit structure data into an intermediate circuit structure representation defined in a quantum intermediate representation language;
generating the parsed circuit structure representation by parsing the intermediate circuit structure representation;
translating the parameter data into an intermediate parameter representation defined in a specified data format; and
generating the parsed parameter representation by parsing the intermediate parameter representation.

20. The computer system of claim 19, wherein the method further comprises:
receiving at least one request message containing the high-level quantum circuit representation; and
extracting the circuit structure data and the parameter data from the at least one request message.
